(19) United States
(12) Patent Application Publication
(10) Pub. No.: US 2024/0416901 A1
(43) Pub. Date: Dec. 19, 2024

(54) Apparatus for controlling autonomous driving and method thereof

(71) Applicants: Hyundai Motor Company, Seoul (KR); Kia Corporation, Seoul (KR)

(72) Inventors: Sang Min Lee, Seoul (KR); Dae Seok Jeon, Hwaseong-Si (KR); Dong Hyun Sung, Hwaseong-Si (KR); Yong Seok Kwon, Suwon-Si (KR); Tae Geun An, Yeongju-Si (KR); Hyoung Jong Wi, Seoul (KR); Joon Ho Lee, Seoul (KR); Eung Seo Kim, Gwacheon-Si (KR); Sang Yeob Lee, Seoul (KR)

(21) Appl. No.: 18/533,302

(22) Filed: Dec. 8, 2023

(30) Foreign Application Priority Data
Jun. 19, 2023 (KR) 10-2023-0078363

(51) Int. Cl. B60W 30/09; B60W 60/00

(52) U.S. Cl. CPC B60W 30/09; B60W 60/005; B60W 2554/20; B60W 2554/402; B60W 2554/4041; B60W 2554/4042; B60W 2556/35

(57) ABSTRACT

Disclosed is an autonomous driving control apparatus. The autonomous driving control apparatus includes a sensor device, a memory, and a control device. For example, the autonomous driving control apparatus identifies an autonomous driving control level of a host vehicle, identifies a first autonomous driving control method corresponding to at least one level higher than or equal to the specified level when the autonomous driving control level is higher than or equal to a specified level, identifies a surrounding object of the host vehicle by using the sensor device while the host vehicle is driving, and performs a first autonomous driving control corresponding to the surrounding object based on the first autonomous driving control method.

### CROSS-REFERENCE TO RELATED APPLICATION

This application claims the benefit of priority to Korean Patent Application No. 10-2023-0078363, filed in the Korean Intellectual Property Office on Jun. 19, 2023, the entire contents of which are incorporated herein by reference.

### TECHNICAL FIELD

The present disclosure relates to an autonomous driving control apparatus and a method thereof, and more particularly, to a technology for efficiently implementing a control method changed depending on an autonomous driving control level.

### BACKGROUND

Various technologies related to autonomous driving are being developed. The autonomous driving may be classified into different types, such as partial autonomous driving, highly autonomous driving, conditional autonomous driving, and/or fully autonomous driving depending on a control level.

An apparatus (e.g., an autonomous driving control apparatus) controlling an autonomous driving vehicle may control the autonomous driving vehicle in different types (or architectures) depending on situations. For example, the autonomous driving control apparatus may selectively use at least part of a plurality of components (e.g., a plurality of controllers) for controlling an autonomous driving vehicle depending on an autonomous driving control level (or step).

However, as the autonomous driving control level is changed while a host vehicle is driving, the autonomous driving control apparatus selectively uses some of the components. Accordingly, inefficient results may occur in terms of hardware resources such as an operation of a memory or computing power. Moreover, because the components are selectively used, unnecessarily large costs may be incurred to produce autonomous driving vehicles.

### SUMMARY

The following summary presents a simplified summary of certain features. The summary is not an extensive overview and is not intended to identify key or critical elements.

An aspect of the present disclosure provides an autonomous driving control apparatus that identifies an autonomous driving control step (or level) for autonomous driving control of a host vehicle, identifies an autonomous driving control method according to the identification result, and controls autonomous driving of the host vehicle based on an identified autonomous driving control method, and a method thereof.

An aspect of the present disclosure provides an autonomous driving control apparatus configured to process data for autonomous driving control by selectively using at least part of a plurality of controllers included in the autonomous driving control apparatus depending on the identified autonomous driving control method, and a method thereof.

An aspect of the present disclosure provides an autonomous driving control apparatus that controls autonomous driving of host vehicle so as to avoid an obstacle (e.g., at least one of a road structure, a vehicle, a sign, or any combination thereof), which is present outside the host vehicle, by using an intermediary device included in at least one controller depending on the identified autonomous driving control method, and a method thereof.

The technical problems to be solved by the present disclosure are not limited to the aforementioned problems, and any other technical problems not mentioned herein will be clearly understood from the following description by those skilled in the art to which the present disclosure pertains.

An apparatus may comprise: a sensor device; a memory configured to store instructions; a and control device operatively coupled to the sensor device and the memory and comprising at least one controller, wherein the instructions, when executed by the control device, cause the apparatus to: determine an autonomous driving control level for a vehicle; based on the autonomous driving control level being higher than a specified level, determine at least one autonomous driving parameter for the autonomous driving control level higher than the specified level; while the vehicle is driving, determine, by using the sensor device, an object on a driving path of the vehicle; and perform, based on the object and based on a first autonomous driving control algorithm, a first autonomous driving control associated with the vehicle, wherein the first autonomous driving control algorithm is changed from a second autonomous driving control algorithm by applying the at least one autonomous driving parameter.

The instructions, when executed by the control device, may cause the apparatus to: based on a second autonomous driving control level being not higher than the specified level, determine the second autonomous driving control algorithm; and perform, based on the second autonomous driving control algorithm, a second autonomous driving control associated with the vehicle, wherein the at least one autonomous driving parameter is not applied on the second autonomous driving control algorithm.

The at least one controller may comprise: a first controller comprising a first sensor fusion device, a determination device, an arbitration device, wherein the determination device is configured to apply the at least one autonomous driving parameter; and a second controller comprising a second sensor fusion device.

The instructions, when executed by the control device, may cause the apparatus to: obtain information for controlling the vehicle by using the sensor device; and transmit at least part of the information to at least one of the first controller, the second controller, or a combination of the first controller and the second controller.

The instructions, when executed by the control device, may cause the apparatus to: process the information by using at least one of the first sensor fusion device, the second sensor fusion device, or a combination of the first sensor fusion device and the second sensor fusion device; and transmit, to the determination device, first data processed by the first sensor fusion device and second data processed by the second sensor fusion device.

The instructions, when executed by the control device, may cause to: the generate, apparatus by using the determination device, a plurality of determination results for avoiding the object; select, by using the arbitration device, at least one determination result from among the plurality of determination results; and perform the first autonomous driving control by performing, based on the selected at least one determination result, the first autonomous driving control.

The instructions, when executed by the control device, may cause the apparatus to: select the at least one determination result, from among the plurality of determination results, based on at least one of: a type of the object, a determination whether the object is a moving object or a stationary object, a size of the object, or a movement speed of the object.

The instructions, when executed by the control device, may cause the apparatus to: based on the autonomous driving control level being higher than the specified level: identify the first autonomous driving control algorithm corresponding to the autonomous driving control level; activate an obstacle avoidance control apparatus corresponding to the autonomous driving control level; and perform the first autonomous driving control further based on the obstacle avoidance control apparatus.

The first autonomous driving control algorithm may comprise at least one of: an increase in driving speed limit, an expansion of sensing data overlap area, a change in user intent identification criterion, or an activation of determination of whether another vehicle cuts in.

The obstacle avoidance control apparatus may comprise a control apparatus for driving control for avoiding a stationary object, wherein the stationary object is an object present on the driving path of the vehicle.

A method may comprise: determining, by a control device, an autonomous driving control level for a vehicle; based on the autonomous driving control level being higher than a specified level, determining, by the control device, at least one autonomous driving parameter for the autonomous driving control level higher than the specified level; while the vehicle is driving, determining, by the control device and by using a sensor device, an object on a driving path of the vehicle; and performing, based on the object and based on a first autonomous driving control algorithm, a first autonomous driving control associated with the vehicle, wherein the first autonomous driving control algorithm is changed from a second autonomous driving control algorithm by applying the at least one autonomous driving parameter.

The method may further comprise: based on a second autonomous driving control level being not higher than the specified level, determining, by the control device, the second autonomous driving control algorithm; and performing, by the control device and based on the second autonomous driving control algorithm, a second autonomous driving control associated with the vehicle, wherein the at least one autonomous driving parameter is not applied on the second autonomous driving control algorithm.

The control device may comprise at least one controller, and wherein the at least one controller comprises: a first controller comprising a first sensor fusion device, a determination device, an arbitration device, wherein the determination device is configured to apply the at least one autonomous driving parameter; and a second controller comprising a second sensor fusion device.

The method may further comprise: obtaining, by the control device, information for controlling the vehicle by using the sensor device; and transmitting, by the control device, at least part of the information to at least one of the first controller, the second controller, or a combination of the first controller and the second controller.

The method may further comprise: processing, by the control device, the information by using at least one of the first sensor fusion device, the second sensor fusion device, or a combination of the first sensor fusion device and the second sensor fusion device; and transmitting, by the control device to the determination device, first data processed by the first sensor fusion device and second data processed by the second sensor fusion device.

The performing, by the control device, of the first autonomous driving control may comprise: generating, by using the determination device, a plurality of determination results for avoiding the object; selecting, by using the arbitration device, at least one determination result from among the plurality of determination results; and performing, by the control device, the first autonomous driving control by performing, based on the selected at least one determination result, the first autonomous driving control.

The selecting of the at least one determination result from among the plurality of determination results may comprise: selecting, by the control device, the at least one determination result, from among the plurality of determination results, based on at least one of: a type of the object, a determination whether the object is a moving object or a stationary object, a size of the object, or a movement speed of the object.

The performing of the first autonomous driving control may comprise: based on the autonomous driving control level being higher than the specified level: identifying, by the control device, the first autonomous driving control algorithm corresponding to the autonomous driving control level; activating, by the control device, an obstacle avoidance control apparatus corresponding to the autonomous driving control level; and performing, by the control device, the first autonomous driving control further based on the obstacle avoidance control apparatus.

The first autonomous algorithm may comprise at least one of: an increase in driving speed limit, an expansion of sensing data overlap area, a change in user intent identification criterion, or an activation of determination of whether another vehicle cuts in.

The obstacle avoidance control apparatus may comprise a control apparatus for driving control for avoiding a stationary object, wherein the stationary object is an object present on the driving path of the vehicle.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing components of an autonomous driving control apparatus

FIG. 2 is a block diagram showing components of an autonomous driving control apparatus;

FIG. 3 is a conceptual diagram illustrating an operation of an autonomous driving control apparatus;

FIG. 4 is a conceptual diagram illustrating an operation of an autonomous driving control apparatus;

FIG. 5 is a conceptual diagram illustrating an operation of an autonomous driving control apparatus;

FIG. 6 is an operation flowchart of an autonomous driving control apparatus;

FIG. 7 is an operation flowchart of an autonomous driving control apparatus; and

FIG. 8 illustrates a computing system related to an autonomous driving control method.

With regard to description of drawings, the same or similar components will be marked by the same or similar reference signs.

### DETAILED DESCRIPTION

Hereinafter, various examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of various configurations and/or implementations of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

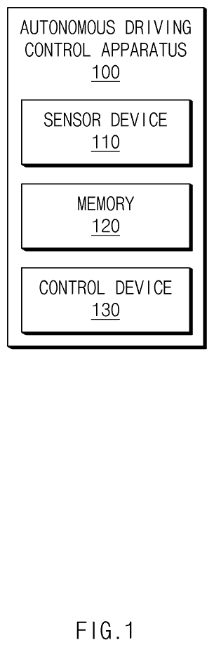

Hereinafter, various examples of the present disclosure will be described in detail with reference to FIGS. 1 to 8.

FIG. 1 is a block diagram showing components of an autonomous driving control apparatus.

An autonomous driving control apparatus 100 may include at least one of a sensor device 110, a memory 120, a control device 130, or any combination thereof. The configuration of the autonomous driving control apparatus 100 shown in FIG. 1 is an example, and aspects of the present disclosure are not limited thereto. For example, the autonomous driving control apparatus 100 may further include components (e.g., at least one of an output device, a communication device, a driver, an input device, an interface device, or any combination thereof) not shown in FIG. 1.

The sensor device 110 may obtain (or sense) various pieces of information used for the driving of a vehicle. For example, the control device 130 may perform autonomous driving control of a host vehicle based on information obtained using the sensor device 110.

For example, the sensor device 110 may include at least one sensor including at least one of a camera, radar, LiDAR, or any combination thereof.

For example, the sensor device 110 may obtain information about an external object (e.g., at least one of a person, another vehicle, a building, a structure, or any combination thereof) by using at least one sensor.

For example, the sensor device 110 may identify an object adjacent to the host vehicle (e.g., a surrounding object, which may be an object in a surrounding space/environment and located in proximity to the vehicle).

For example, the sensor device 110 may obtain information (e.g., at least one of a driving speed, a driving lane, a separation distance from the host vehicle, a vehicle type, an expected driving route, or any combination thereof) about at least another vehicle that is driving while being adjacent to the host vehicle.

For example, the sensor device 110 may obtain information about a stationary object that is present while being adjacent to the host vehicle. The stationary object may include, for example, at least one of a road structure (e.g., a guardrail), a stationary moving object (e.g., a vehicle, a creature, or the like), or any combination thereof.

For example, the sensor device 110 may obtain data (e.g., sensor fusion data) through a sensor set including at least one sensor. For example, the sensor device 110 may include a plurality of sensor sets for obtaining data for each of a plurality of areas logically and/or physically separated from each other.

For example, the sensor device 110 may deliver data obtained through a sensor set including at least one sensor to different sensor fusion devices, and each of the sensor fusion devices may process the received data.

The memory 120 may store instructions or data. For example, the memory 120 may store one or more instructions that cause the autonomous driving control apparatus 100 to perform various operations when executed by the control device 130.

For example, the memory 120 and the control device 130 may be implemented as one chipset. The control device 130 may include at least one of a communication processor or a modem.

For example, the memory 120 may store information related to states and/or operations of components (e.g., at least one of an engine control unit (ECU), the sensor device 110, the control device 130, or any combination thereof) of the host vehicle.

For example, the memory 120 may store various pieces of information related to the autonomous driving control apparatus 100. For example, the memory 120 may store information about the operation history of the control device 130.

The control device 130 may be operatively connected to the sensor device 110 and/or the memory 120. For example, the control device 130 may control the operation of the sensor device 110 and/or the memory 120.

For example, the control device 130 may identify an autonomous driving control step of the host vehicle.

For example, the control device 130 may perform autonomous driving control on the host vehicle based on at least one step among various types of autonomous driving control steps (or levels) (e.g., Level 1 to Level 5) and may identify the autonomous driving control step being performed.

For example, the control device 130 may determine whether the autonomous driving control step is higher than or equal to a specified step.

For example, the specified step may be Level 3 (e.g., conditional autonomous driving control step), but this is an example. Aspects of the present disclosure are not limited thereto. The specified step may be changed in real time based on at least one of a user's settings, a driving environment of a host vehicle, a manufacturer's intent, software update, or any combination thereof.

For example, if it is identified that the autonomous driving control step for control of the host vehicle is higher than or equal to a specified step, the control device 130 may identify a first autonomous driving control method corresponding to at least one step (e.g., Level 3 to Level 5) that is higher than or equal to the specified step. For example, the first autonomous driving control method may include a control method for at least one of emergency maneuver (EM), dynamic object fusion (DOF), static object fusion (EM SOF), object (O), roadedge (EM SOF R), or any combination thereof.

For example, at least one of application of parameters (e.g., at least one of a driving limit speed, a sensing data overlap area size, a user intent identification criterion, other vehicle driving determination, or any combination thereof) related to specifications and performance for at least one of conditional autonomous driving control, fully autonomous driving control, or any combination thereof, activation of an obstacle avoidance control apparatus, or any combination thereof may be included.

For example, if it is identified that the autonomous driving control step for control of the host vehicle is lower than the specified step, the control device 130 may identify a second autonomous driving control method corresponding to at least one step (e.g., Level 1 or Level 2) lower than the specified step. For example, the second autonomous driving control method may include a control method forward collision-avoidance assist (FCA).

For example, after identifying the first autonomous driving control method, the control device 130 may identify a surrounding object of the host vehicle by using the sensor device 110.

For example, the control device 130 may identify (or detect) at least one surrounding object, which is present around the host vehicle, by using the sensor device 110.

For example, the control device 130 may obtain information about at least one surrounding object, which is present in front of the host vehicle, by using the sensor device 110. For example, the surrounding object may obtain information (e.g., at least one of a driving speed, a driving lane, a separation distance from the host vehicle, a vehicle type, an expected driving route, or any combination thereof) about at least one of a dynamic object (e.g., at least one of a moving vehicle, a creature, or any combination thereof), a static object (e.g., at least one of a road structure, a stationary vehicle, or any combination thereof), or any combination thereof.

For example, the control device 130 may obtain information about a surrounding object (e.g., a vehicle, a road structure, or the like) adjacent to the host vehicle by using the sensor device 110 and may determine the possibility of collision between the host vehicle and the surrounding object.

For example, the control device 130 may perform first autonomous driving control corresponding to a surrounding object based on the first autonomous driving control method.

For example, the control device 130 may identify a control algorithm corresponding to at least one step, which is higher than or equal to a specified control step, based on the first autonomous driving control method and/or may activate an obstacle avoidance control apparatus.

For example, the control algorithm may include at least one of an increase in driving speed limit, expansion of sensing data overlap area, a change in user intent identification criterion, activation of determination of whether another vehicle cuts in, or any combination thereof.

For example, the obstacle avoidance control apparatus may include a control apparatus for driving control for avoiding a stationary object, which is present on a driving path of the host vehicle and has a possibility of colliding with the host vehicle. The obstacle avoidance control apparatus may be a separate device physically separated from the control device 130, or the obstacle avoidance control apparatus and the control device 130 may be implemented as one chipset.

For example, the control device 130 may perform first autonomous driving control corresponding to a surrounding object sensed by using the sensor device 110 based on the first control method for at least one of the autonomous control algorithm, the obstacle avoidance control apparatus, or any combination thereof.

For example, the control device 130 may perform different autonomous driving controls based on whether the surrounding object is a dynamic object or a static object

For example, the control device 130 may perform different autonomous driving controls based on at least one of a separation distance from the surrounding object, a driving speed, an expected driving route, or any combination thereof.

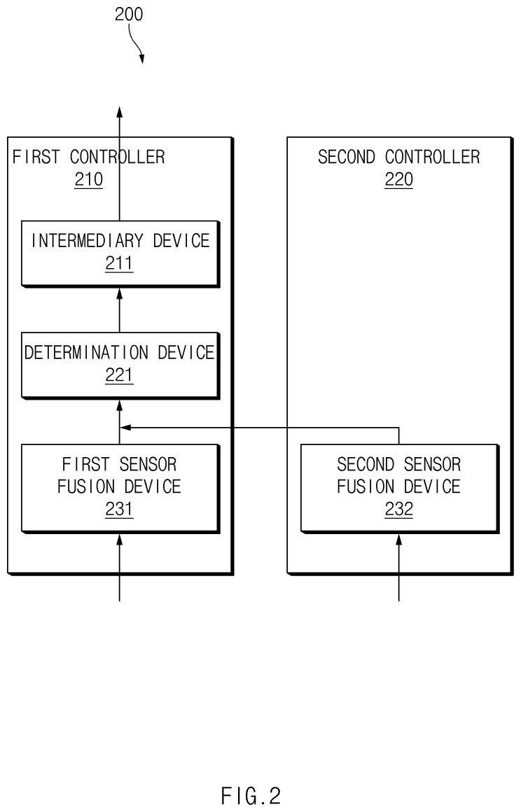

For example, the control device 130 may include a plurality of controllers (e.g., a first controller 210 and a second controller 220 in FIG. 2). The control device 130 may generate at least one determination result by using at least part of the sensing data obtained and processed by using the plurality of controllers, may identify one determination result for autonomous driving control for the host vehicle from among at least one determination result, and may control the host vehicle based on the identified determination result. An operation of the control device 130 using the divided controllers will be described in detail in with reference to FIG. 2.

FIG. 2 is a block diagram showing components of an autonomous driving control apparatus.

A control device 200 (e.g., the control device 130 of FIG. 1) may include a plurality of controllers 210 and 220. For example, the control device 200 may include the first controller 210 and the second controller 220.

Components of the control device 200 illustrated in FIG. 2 is an example, and aspects of the present disclosure are not limited thereto. For example, the control device 200 may further include one or more controllers. For another example, each of the first controller 210 and/or the second controller 220 may be a separate control apparatus that is present outside the control device 200 and is electrically connected to the control device 200.

The first controller 210 may include at least one of a first sensor fusion device 231, a determination device 221, an intermediary device 211 (e.g., an arbitration device), or any combination thereof.

The second controller 220 may include a second sensor fusion device 232.

The control device 200 may deliver various pieces of information obtained by using a sensor device (e.g., the sensor device 110 in FIG. 1) to the first sensor fusion device 231 of the first controller 210 and/or the second sensor fusion device 232 of the second controller 220.

For example, while the control device 200 performs autonomous driving control on the host vehicle, the control device 200 may identify a surrounding object adjacent to the host vehicle by using a sensor device. The control device 200 may obtain information for controlling the host vehicle by using, for example, a sensor device. The control device 200 may deliver information obtained by using the sensor device to at least one of the first controller 210, the second controller 220, or any combination thereof.

The control device 200 may process the obtained information through a sensor fusion device.

For example, the control device 200 may perform post-processing on at least part of pieces of information, which are obtained by using the sensor device, by using the first sensor fusion device 231 included in the first controller 210.

For example, the control device 200 may perform post-processing on at least part of pieces of information, which are obtained by using the sensor device, by using the second sensor fusion device 232 included in the second controller 220.

The control device 200 may deliver the result processed by using the sensor fusion device to the determination device 221 of the first controller 210.

For example, the control device 200 may deliver first data processed through the first sensor fusion device 231 and second data processed through the second sensor fusion device 232 to the determination device 221 included in the first controller 210.

The control device 200 may generate a plurality of determination results, which are generated based on the first data and the second data, by using the determination device 221.

For example, the determination device 221 may generate the plurality of determination results regarding a control method that allows the host vehicle to drive while the host vehicle avoids a surrounding object, based on the first data and the second data. For example, the determination device 221 may include an obstacle avoidance control apparatus.

The control device 200 may select at least one determination result from among the plurality of generated determination results.

For example, the control device 200 may select at least one determination result from among the plurality of determination results by using the intermediary device 211 included in the first controller 210.

For example, the control device 200 may allow the intermediary device 211 to select at least one determination result from among the plurality of determination results based on at least one of the type of the surrounding object, whether the surrounding object is moved, the size of the surrounding object, a movement speed of the surrounding object, a separation distance from the host vehicle, an expected movement path of the surrounding object, or any combination thereof.

The control device 200 may perform autonomous driving control of the host vehicle based on the selected at least one determination result.

For example, the control device 200 may perform autonomous driving control for avoiding a surrounding object based on the autonomous driving control method for at least one of a control algorithm for the autonomous driving control, the activated obstacle avoidance control apparatus, the selected at least one determination result, or any combination thereof.

FIG. 2 illustrates that the second controller 220 includes only the second sensor fusion device 232 without including a separate determination device or intermediary device. When the autonomous driving control step is changed, the autonomous driving control apparatus may quickly perform avoidance control of the host vehicle through the structure shown in FIG. 2. In addition, efficient and stable autonomous driving control performance may be provided by reducing the number of installed hardware or the amount of resources.

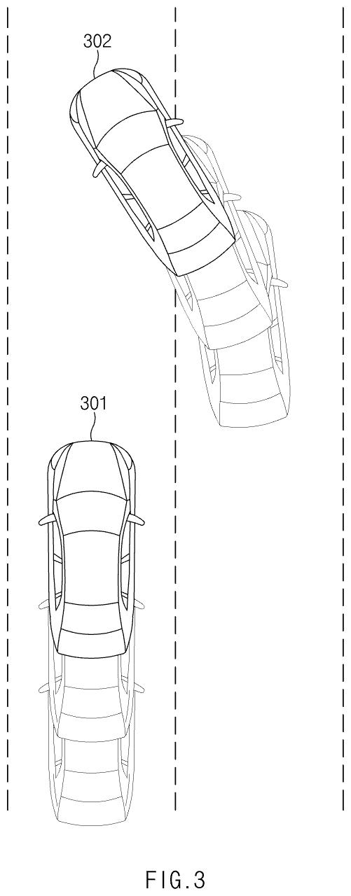

FIG. 3 is a conceptual diagram illustrating an operation of an autonomous driving control apparatus.

An autonomous driving control apparatus (e.g., the autonomous driving control apparatus 100 of FIG. 1) may identify a surrounding object 302 (e.g., a dynamic object or another moving vehicle) adjacent to a host vehicle 301 while performing autonomous driving control on the host vehicle 301.

For example, the surrounding object 302 may be another vehicle that is present in an area in front of the host vehicle 301 and is cutting into a lane on which the host vehicle 301 is driving.

For example, the autonomous driving control apparatus may identify information about at least one of the size of the surrounding object 302, a vehicle type of the surrounding object 302, a real-time location of the surrounding object 302, a driving speed of the surrounding object 302, an expected driving route of the surrounding object 302, or any combination thereof.

For example, it may be identified that the autonomous driving control step for the host vehicle 301 is higher than or equal to a specified step. Afterward, if the surrounding object 302 cuts in to a lane in front of the host vehicle 301 as shown in FIG. 3, the autonomous driving control apparatus may identify an autonomous driving control method based on at least one of an autonomous driving control algorithm corresponding to at least one step higher than or equal to the specified step, an activated obstacle avoidance control apparatus, information about the surrounding object 302, or any combination thereof, and may control autonomous driving of the host vehicle 301 based on the identified method.

For example, in the situation shown in FIG. 3, an autonomous driving control apparatus may perform autonomous driving control on the host vehicle 301 based on EM DOF.

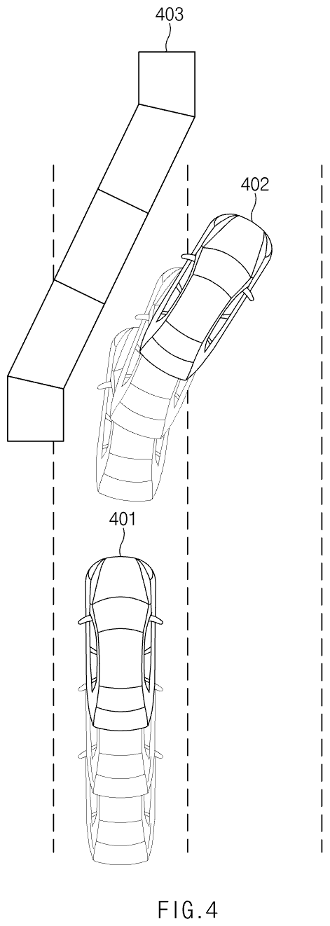

FIG. 4 is a conceptual diagram illustrating an operation of an autonomous driving control apparatus.

An autonomous driving control apparatus (e.g., the autonomous driving control apparatus 100 of FIG. 1) may identify surrounding objects 402 and 403 (e.g., a dynamic object and a static object) adjacent to a host vehicle 401 while performing autonomous driving control on the host vehicle 401.

For example, the first surrounding object 402 may be another vehicle that is present in an area in front of the host vehicle 401 and is moving (or cut-out) from a lane, on which the host vehicle 401 is driving, to another lane.

For example, the autonomous driving control apparatus may identify information about at least one of the size of the first surrounding object 402, a vehicle type of the first surrounding object 402, a real-time location of the first surrounding object 402, a driving speed of the first surrounding object 402, an expected driving route of the first surrounding object 402, or any combination thereof.

For example, the second surrounding object 403 may include a static object (e.g., a road structure) that is present in a front area of the host vehicle 401 and is stationary.

For example, the autonomous driving control apparatus may identify information about at least one of the size of the second surrounding object 403, a location of the second surrounding object 403, a separation distance from the host vehicle 401, or any combination thereof.

For example, it may be identified that the autonomous driving control step for the host vehicle 401 is higher than or equal to a specified step. Afterward, if the first surrounding object 402 that cuts out from a lane in front of the host vehicle 401 is identified and the second surrounding object 403 is identified as shown in FIG. 4, the autonomous driving control apparatus may identify an autonomous driving control method based on at least one of an autonomous driving control algorithm corresponding to at least one step higher than or equal to the specified step, an activated obstacle avoidance control apparatus, information about the second surrounding object 403, or any combination thereof, and may control autonomous driving of the host vehicle 401 based on the identified method.

For example, in the situation shown in FIG. 4, an autonomous driving control apparatus may perform autonomous driving control on the host vehicle 401 based on EM SOF-R.

For example, in the situation shown in FIG. 4, when the second surrounding object 403 corresponds to a general stationary object other than a road obstacle, the autonomous driving control apparatus may perform autonomous driving control on the host vehicle 401 based on EM SOF-O.

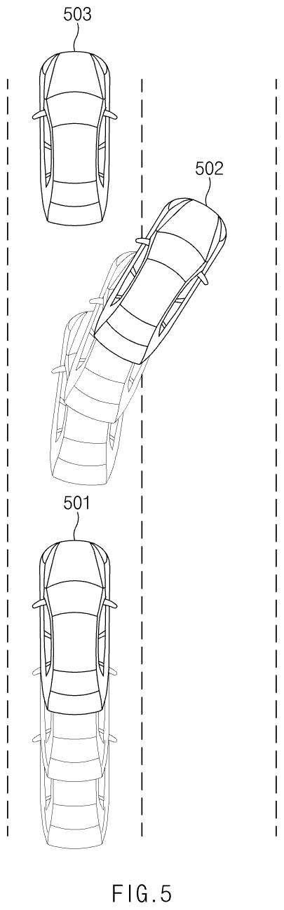

FIG. 5 is a conceptual diagram illustrating an operation of an autonomous driving control apparatus.

An autonomous driving control apparatus (e.g., the autonomous driving control apparatus 100 of FIG. 1)) may identify surrounding objects 502 and 503 (e.g., a dynamic object and a dynamic object) adjacent to a host vehicle 501 while performing autonomous driving control on the host vehicle 501.

For example, the first surrounding object 502 may be another vehicle that is present in an area in front of the host vehicle 501 and is moving (or cut-out) from a lane, on which the host vehicle 501 is driving, to another lane.

For example, the autonomous driving control apparatus may identify information about at least one of the size of the first surrounding object 502, a vehicle type of the first surrounding object 502, a real-time location of the first surrounding object 502, a driving speed of the first surrounding object 502, an expected driving route of the first surrounding object 502, or any combination thereof.

For example, the second surrounding object 503 may be another vehicle that is present in an area in front of the host vehicle 501 and is driving on the same lane as the host vehicle 501 in front of the first surrounding object 502.

For example, the autonomous driving control apparatus may identify information about at least one of the size of the second surrounding object 503, a vehicle type of the second surrounding object 503, a real-time location of the second surrounding object 503, a driving speed of the second surrounding object 503, an expected driving route of the second surrounding object 503, or any combination thereof.

For example, if the autonomous driving control step for the host vehicle is not identified (or an operational error occurs), the autonomous driving control step is lower than the specified step, or it is identified that the autonomous driving control is not performed, the autonomous driving control apparatus may control autonomous driving of the host vehicle 501 based on an autonomous driving control method different from the method in the description of FIGS. 3 and 4 described above.

For example, in the situation shown in FIG. 5, an autonomous driving control apparatus may perform autonomous driving control on the host vehicle 501 based on FCA.

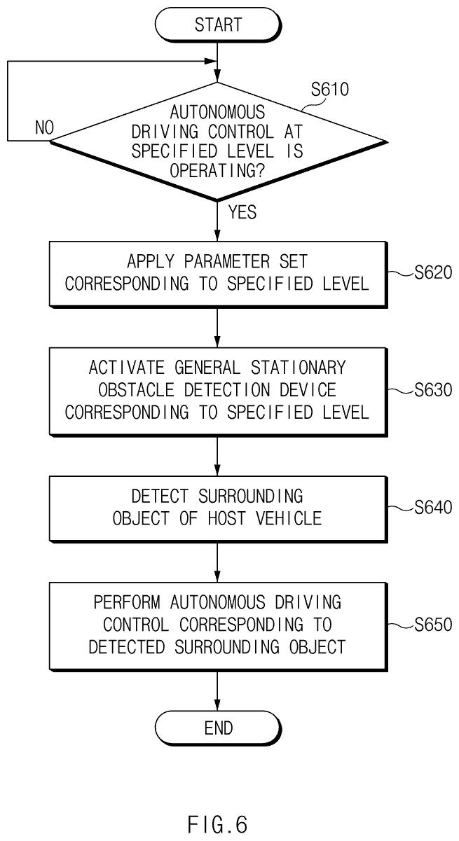

FIG. 6 is an operation flowchart of an autonomous driving control apparatus.

An autonomous driving control apparatus (e.g., the autonomous driving control apparatus 100 of FIG. 1) may perform operations described in FIG. 6. For example, at least part of components (e.g., at least one of the sensor device 110, the memory 120, the control device 130, or any combination thereof) included in the autonomous driving control apparatus may be configured to perform the operations of FIG. 6.

In the following example, operation S610 to operation S650 may be sequentially performed, but are not always performed sequentially. For example, the order of operations may be changed, and at least two operations may be performed in parallel. Moreover, descriptions corresponding to or identical to the above-mentioned descriptions given with reference to FIG. 6 may be briefly described or omitted to avoid redundancy.

The autonomous driving control apparatus may determine whether autonomous driving control at a specified level is operating (S610).

For example, the specified level may be a step of autonomous driving control level 3 (Level 3), but this may be an example. Aspects of the present disclosure are not limited thereto. The specified level may be changed in real time based on at least one of a user's settings, a driving environment of a host vehicle, a manufacturer's intent, software update, or any combination thereof.

For example, if the autonomous driving control at the specified level is operating (e.g., operation S610—Yes), the autonomous driving control apparatus may perform operation S620.

For example, if the autonomous driving control at the specified level is not operating (e.g., operation S610—No), the autonomous driving control apparatus may repeatedly perform operation S610.

The autonomous driving control apparatus may apply a parameter set corresponding to the specified level (S620).

For example, the autonomous driving control apparatus may perform a control algorithm to implement autonomous driving control at the specified level by identifying and applying a parameter set for expansion of at least one of driving specifications, performance, or any combination thereof corresponding to the specified level to control the host vehicle. For example, the control algorithm may include at least one of an increase in driving speed limit, expansion of sensing data overlap area, a change in user intent identification criterion, activation of determination of whether another vehicle cuts in, or any combination thereof.

The autonomous driving control apparatus may activate a general stationary obstacle detection device corresponding to the specified level (S630).

For example, the general stationary obstacle detection device may include a control apparatus for driving control for avoiding a stationary object, which is present on a driving path of the host vehicle and has a possibility of colliding with the host vehicle.

For example, the general stationary obstacle detection device and a control device included in the autonomous driving control apparatus may be implemented as one chipset. For another example, the general stationary obstacle detection device may be implemented as a separate control apparatus that is physically separated from and electrically connected to the control device included in the autonomous driving control apparatus.

The autonomous driving control apparatus may detect a surrounding object of a host vehicle (S640).

For example, the autonomous driving control apparatus may detect at least one surrounding object, which is likely to collide with the host vehicle, from among surrounding objects of the host vehicle by using a sensor device.

The autonomous driving control apparatus may perform autonomous driving control corresponding to the detected surrounding object (S650).

For example, the autonomous driving control apparatus may perform avoidance control of the host vehicle based on the control algorithm applied in operation S620, the general stationary obstacle detection device activated in operation S630, and information about the surrounding object detected in operation S640.

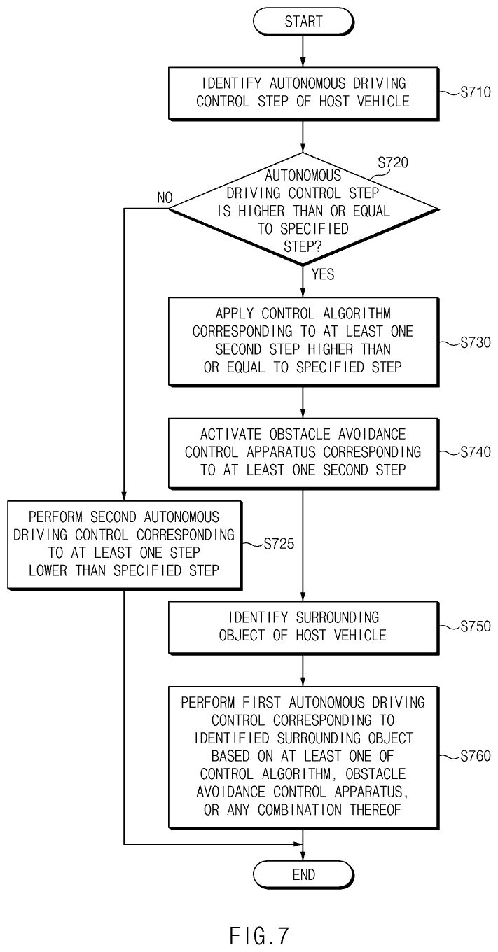

FIG. 7 is an operation flowchart of an autonomous driving control apparatus.

An autonomous driving control apparatus (e.g., the autonomous driving control apparatus 100 of FIG. 1) may perform operations described in FIG. 7. For example, at least part of components (e.g., at least one of the sensor device 110, the memory 120, the control device 130, or any combination thereof) included in the autonomous driving control apparatus may be configured to perform the operations of FIG. 7.

In the following example, operation S710 to operation S760 may be sequentially performed, but are not always performed sequentially. For example, the order of operations may be changed, and at least two operations may be performed in parallel. Moreover, descriptions corresponding to or identical to the above-mentioned descriptions given with reference to FIG. 7 may be briefly described or omitted to avoid redundancy.

The autonomous driving control apparatus may identify an autonomous driving control step of a host vehicle (S710).

For example, the autonomous driving control apparatus may identify the autonomous driving control step for the host vehicle in real time. For example, the autonomous driving control step may be one level of level 1 to level 5, but this is an example. The autonomous driving control step may be defined as a different name depending on the criteria or grounds for distinguishing steps.

The autonomous driving control apparatus may determine whether the autonomous driving control step is higher than or equal to a specified step (S720).

For example, the specified step may be level 3. However, this is an example, and aspects of the present disclosure are not limited thereto. The specified step may be changed in real time based on at least one of a user's settings, a driving environment of a host vehicle, a manufacturer's intent, software update, or any combination thereof.

For example, if the autonomous driving control step is higher than or equal to the specified step (e.g., operation S720—Yes), the autonomous driving control apparatus may perform operation S730.

For example, if the autonomous driving control step is lower than the specified step (e.g., operation S720—No), the autonomous driving control apparatus may perform operation S725.

The autonomous driving control apparatus may perform a second autonomous driving control corresponding to at least one step lower than the specified step (S725).

For example, the second autonomous driving control method may include a control method for forward collision-avoidance assist (FCA).

The autonomous driving control apparatus may apply a control algorithm corresponding to at least one step higher than or equal to the specified step to an algorithm for controlling the host vehicle (S730).

For example, the control algorithm may include at least one of an increase in driving speed limit, expansion of sensing data overlap area, a change in user intent identification criterion, activation of determination of whether another vehicle cuts in, or any combination thereof.

The autonomous driving control apparatus may activate an obstacle avoidance control apparatus corresponding to at least one step (S740).

For example, the obstacle avoidance control apparatus may include a a control apparatus for driving control for avoiding a stationary object, which is present on a driving path of the host vehicle and has a possibility of colliding with the host vehicle. The obstacle avoidance control apparatus may be a separate device physically separated from the control device, or the obstacle avoidance control apparatus and the control device may be implemented as one chipset.

The autonomous driving control apparatus may identify a surrounding object of the host vehicle (S750).

For example, the autonomous driving control apparatus may process information obtained by using a sensor device and may identify various pieces of information about the surrounding object based on the processed result.

The autonomous driving control apparatus may perform a first autonomous driving control corresponding to the identified surrounding object based on at least one of a control algorithm, an obstacle avoidance control apparatus, or any combination thereof (S760).

For example, the autonomous driving control apparatus may perform different first autonomous driving controls based on whether the identified surrounding object is a dynamic object or a static object, and may allow the host vehicle to avoid the surrounding object based on the first autonomous driving control.

According to an aspect of the present disclosure, an autonomous driving control apparatus includes a sensor device, a memory configured to store instructions, and a control device operatively connected to the sensor device and the memory and including at least one controller. For example, the instructions, when executed by the control device, cause the autonomous driving control apparatus to identify an autonomous driving control level of a host vehicle, to identify a first autonomous driving control method corresponding to at least one level higher than or equal to the specified level when the autonomous driving control level is higher than or equal to a specified level, to identify a surrounding object of the host vehicle by using the sensor device while the host vehicle is driving, and to perform a first autonomous driving control corresponding to the surrounding object based on the first autonomous driving control method.

When executed by the control device, the instructions may cause the autonomous driving control apparatus to identify a second autonomous driving control method corresponding to at least one level lower than the specified level when the autonomous driving control level is lower than the specified level, and to perform autonomous driving control on the host vehicle based on the second autonomous driving control method.

The at least one controller may include a first controller including at least one of a first sensor fusion device, a determination device, an intermediary device, or a combination of the first sensor fusion device, the determination device, and the intermediary device; and a second controller including a second sensor fusion device.

When executed by the control device, the instructions may cause the autonomous driving control apparatus to obtain information for controlling the host vehicle by using the sensor device, and to deliver at least part of the information to at least one of the first controller, the second controller, or a combination of the first controller and the second controller.

When executed by the control device, the instructions may cause the autonomous driving control apparatus to process the information by using at least one of the first sensor fusion device, second the sensor fusion device, or a combination of the first sensor fusion device and the second sensor fusion device, and to deliver first data processed through the first sensor fusion device and second data processed through the second sensor fusion device to the determination device included in the first controller.

When executed by the control device, the instructions may cause the autonomous driving control apparatus to generate a plurality of determination results for avoiding the surrounding object by using the determination device, to select at least one determination result from among the plurality of determination results by using the intermediary device, and to perform the first autonomous driving control corresponding to the surrounding object based on the selected at least one determination result.

When executed by the control device, the instructions may cause the autonomous driving control apparatus to select the at least one determination result from among the plurality of determination results based on at least one of a type of the surrounding object, whether the surrounding object is moved, a size of the surrounding object, a movement speed of the surrounding object, or a combination of the type of the surrounding object, whether the surrounding object is moved, the size of the surrounding object, and the movement speed of the surrounding object.

When executed by the control device, the instructions may cause the autonomous driving control apparatus, when the autonomous driving control level is higher than or equal to the specified level, to identify a control algorithm corresponding to the at least one level higher than or equal to the specified level, to activate an obstacle avoidance control apparatus corresponding to the at least one level higher than or equal to the specified level, and to perform the first autonomous driving control corresponding to the surrounding object based on the first autonomous driving control method for at least one of the control algorithm, the obstacle avoidance control apparatus, or a combination of the control algorithm and the obstacle avoidance control apparatus.

The control algorithm may include at least one of an increase in driving speed limit, expansion of sensing data overlap area, a change in user intent identification criterion, activation of determination of whether another vehicle cuts in, or a combination of the increase in the driving speed limit, the expansion of the sensing data overlap area, the change in the user intent identification criterion, and the activation of the determination of whether the another vehicle cuts in.

The obstacle avoidance control apparatus may include a control apparatus for driving control for avoiding a stationary object, which is present on a driving path of the host vehicle and has a possibility of colliding with the host vehicle.

According to an aspect of the present disclosure, an autonomous driving control method includes identifying, by a control device, an autonomous driving control level of a host vehicle, identifying, by the control device, a first autonomous driving control method corresponding to at least one level higher than or equal to the specified level when the autonomous driving control level is higher than or equal to a specified level, identifying, by the control device, a surrounding object of the host vehicle by using a sensor device while the host vehicle is driving, and performing, by the control device, a first autonomous driving corresponding control to the surrounding object based on the first autonomous driving control method.

The autonomous driving control method may further include identifying, by the control device, a second autonomous driving control method corresponding to at least one level lower than the specified level when the autonomous driving control level is lower than the specified level, and performing, by the control device, autonomous driving control on the host vehicle based on the second autonomous driving control method.

The control device may include at least one controller. The at least one controller may include a first controller including at least one of a first sensor fusion device, a determination device, an intermediary device, or a combination of the first sensor fusion device, the determination device, and the intermediary device and a second controller including a second sensor fusion device.

The identifying, by the control device, of the surrounding object of the host vehicle by using the sensor device while the host vehicle is driving may further include obtaining, by the control device, information for controlling the host vehicle by using the sensor device, and delivering, by the control device, at least part of the information to at least one of the first controller, the second controller, or a combination of the first controller and the second controller.

The identifying, by the control device, of the surrounding object of the host vehicle by using the sensor device while the host vehicle is driving may further include processing, by the control device, the information by using at least one of the first sensor fusion device, the second sensor fusion device, or a combination of the first sensor fusion device and the second sensor fusion device, and delivering, by the control device, first data processed through the first sensor fusion device and second data processed through the second sensor fusion device to the determination device included in the first controller.

The performing, by the control device, of the first autonomous driving control corresponding to the surrounding object based on the first autonomous driving control method may further include generating, by the control device, a plurality of determination results for avoiding the surrounding object by using the determination device, selecting, by the control device, at least one determination result from among the plurality of determination results by using the intermediary device, and performing, by the control device, the first autonomous driving control corresponding to the surrounding object based on the selected at least one determination result.

The selecting, by the control device, of the at least one determination from result among the plurality of determination results by using the intermediary device may include selecting, by the control device, the at least one determination result from among the plurality of determination results based on at least one of a type of the surrounding object, whether the surrounding object is moved, a size of the surrounding object, a movement speed of the surrounding object, or a combination of the type of the surrounding object, whether the surrounding object is moved, the size of the surrounding object, and the movement speed of the surrounding object.

The performing, by the control device, of the first autonomous driving control corresponding to the surrounding object based on the first autonomous driving control method may further include, when the autonomous driving control level is higher than or equal to a specified level, identifying, by the control device, a control algorithm corresponding to the at least one level higher than or equal to the specified level, activating, by the control device, an obstacle avoidance control apparatus corresponding to the at least one level higher than or equal to the specified level, and performing, by the control device, the first autonomous driving control corresponding to the surrounding object based on the first autonomous driving control method for at least one of the control algorithm, the obstacle avoidance control apparatus, or a combination of the control algorithm and the obstacle avoidance control apparatus.

The control algorithm may include at least one of an increase in driving speed limit, expansion of sensing data overlap area, a change in user intent identification criterion, activation of determination of whether another vehicle cuts in, or a combination of the increase in the driving speed limit, the expansion of the sensing data overlap area, the change in the user intent identification criterion, and the activation of the determination of whether the another vehicle cuts in.

The obstacle avoidance control apparatus may include a control apparatus for driving control for avoiding a stationary object, which is present on a driving path of the host vehicle and has a possibility of colliding with the host vehicle.

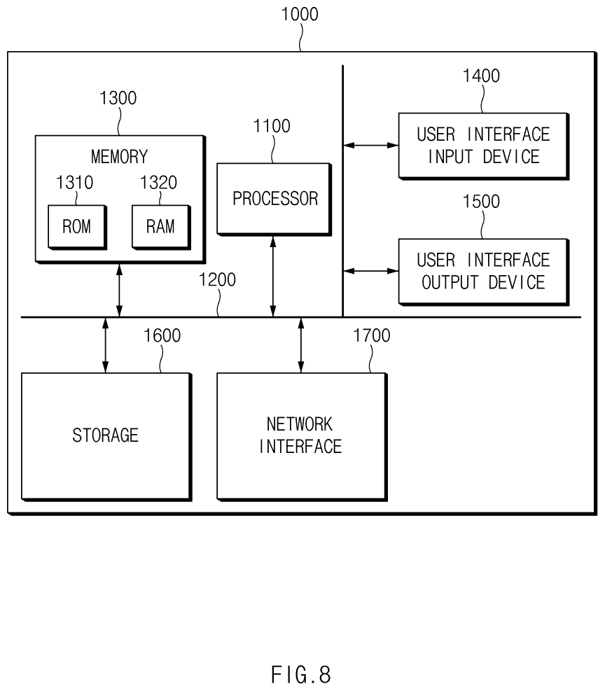

FIG. 8 illustrates a computing system related to an autonomous driving control method.

Referring to FIG. 8, a computing system 1000 related to an autonomous driving control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the features disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or additionally, storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, aspects of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to one or more aspects of the present disclosure, an autonomous driving control apparatus and the effect of a method there of are described as follows.

Moreover, according to one or more aspects of the present disclosure, the autonomous driving control apparatus may efficiently perform autonomous driving control on a host vehicle without additional costs or excessive resource consumption by switching a control structure (or architecture) as an autonomous driving control situation (e.g., control step) for controlling the host vehicle is changed.

Furthermore, according to one or more aspects of the present disclosure, a control device including at least one controller may reduce latency occurring in a control process by adaptively switching and selecting a controller for controlling the host vehicle when an error occurs in a part of controllers during autonomous driving control, and may perform autonomous driving control that lowers the probability of an accident by quickly controlling the host vehicle in an emergency situation by mounting an intermediary device in one controller.

Furthermore, according to one or more aspects of the present disclosure, as an autonomous driving control level is switched, an autonomous driving control may be performed based on a stable control environment when a control area is expanded in different control algorithms such as specifications, performance, and required components.

Besides, a variety of effects directly or indirectly understood through the present disclosure may be provided.

Hereinabove, although the present disclosure has been described with reference to some examples and the accompanying drawings, aspects of the present disclosure are not limited thereto, but may be variously modified and altered by those skilled in the art to which the present disclosure pertains without departing from the spirit and scope of the present disclosure claimed in the following claims.

What is claimed is:

1. An apparatus, the apparatus comprising:
a sensor device;
a memory configured to store instructions; and
a control device operatively coupled to the sensor device and the memory and comprising at least one controller,
wherein the instructions, when executed by the control device, cause the apparatus to:
determine an autonomous driving control level for a vehicle;
based on the autonomous driving control level being higher than a specified level, determine at least one autonomous driving parameter for the autonomous driving control level higher than the specified level;
while the vehicle is driving, determine, by using the sensor device, an object on a driving path of the vehicle; and
perform, based on the object and based on a first autonomous driving control algorithm, a first autonomous driving control associated with the vehicle, wherein the first autonomous driving control algorithm is changed from a second autonomous driving control algorithm by applying the at least one autonomous driving parameter.

2. The apparatus of claim 1, wherein the instructions, when executed by the control device, cause the apparatus to:
based on a second autonomous driving control level being not higher than the specified level, determine the second autonomous driving control algorithm; and
perform, based on the second autonomous driving control algorithm, a second autonomous driving control associated with the vehicle, wherein the at least one autonomous driving parameter is not applied on the second autonomous driving control algorithm.

3. The apparatus of claim 1, wherein the at least one controller comprises:
a first controller comprising a first sensor fusion device, a determination device, an arbitration device, wherein the determination device is configured to apply the at least one autonomous driving parameter; and
a second controller comprising a second sensor fusion device.

4. The apparatus of claim 3, wherein the instructions, when executed by the control device, cause the apparatus to:
obtain information for controlling the vehicle by using the sensor device; and
transmit at least part of the information to at least one of the first controller, the second controller, or a combination of the first controller and the second controller.

5. The apparatus of claim 4, wherein the instructions, when executed by the control device, cause the apparatus to:
process the information by using at least one of the first sensor fusion device, the second sensor fusion device, or a combination of the first sensor fusion device and the second sensor fusion device; and
transmit, to the determination device, first data processed by the first sensor fusion device and second data processed by the second sensor fusion device.

6. The apparatus of claim 3, wherein the instructions, when executed by the control device, cause the apparatus to:
generate, by using the determination device, a plurality of determination results for avoiding the object;
select, by using the arbitration device, at least one determination result from among the plurality of determination results; and
perform the first autonomous driving control by performing, based on the selected at least one determination result, the first autonomous driving control.

7. The apparatus of claim 6, wherein the instructions, when executed by the control device, cause the apparatus to:
select the at least one determination result, from among the plurality of determination results, based on at least one of:
a type of the object,
a determination whether the object is a moving object or a stationary object,
a size of the object, or
a movement speed of the object.

8. The apparatus of claim 1, wherein the instructions, when executed by the control device, cause the apparatus to:
based on the autonomous driving control level being higher than the specified level:
identify the first autonomous driving control algorithm corresponding to the autonomous driving control level;
activate an obstacle avoidance control apparatus corresponding to the autonomous driving control level; and
perform the first autonomous driving control further based on the obstacle avoidance control apparatus.

9. The apparatus of claim 8, wherein the first autonomous driving control algorithm comprises at least one of: an increase in driving speed limit, an expansion of sensing data overlap area, a change in user intent identification criterion, or an activation of determination of whether another vehicle cuts in.

10. The apparatus of claim 8, wherein the obstacle avoidance control apparatus comprises a control apparatus for driving control for avoiding a stationary object, wherein the stationary object is an object present on the driving path of the vehicle.

11. A method comprising:
determining, by a control device, an autonomous driving control level for a vehicle;
based on the autonomous driving control level being higher than a specified level, determining, by the control device, at least one autonomous driving parameter for the autonomous driving control level higher than the specified level;
while the vehicle is driving, determining, by the control device and by using a sensor device, an object on a driving path of the vehicle; and
performing, based on the object and based on a first autonomous driving control algorithm, a first autonomous driving control associated with the vehicle, wherein the first autonomous driving control algorithm is changed from a second autonomous driving control algorithm by applying the at least one autonomous driving parameter.

12. The method of claim 11, further comprising:
based on a second autonomous driving control level being not higher than the specified level, determining, by the control device, the second autonomous driving control algorithm; and
performing, by the control device and based on the second autonomous driving control algorithm, a second autonomous driving control associated with the vehicle, wherein the at least one autonomous driving parameter is not applied on the second autonomous driving control algorithm.

13. The method of claim 11, wherein the control device comprises at least one controller, and
wherein the at least one controller comprises:
a first controller comprising a first sensor fusion device, a determination device, an arbitration device, wherein the determination device is configured to apply the at least one autonomous driving parameter; and
a second controller comprising a second sensor fusion device.

14. The method of claim 13, further comprising:
obtaining, by the control device, information for controlling the vehicle by using the sensor device; and
transmitting, by the control device, at least part of the information to at least one of the first controller, the second controller, or a combination of the first controller and the second controller.

15. The method of claim 14, further comprising:
processing, by the control device, the information by using at least one of the first sensor fusion device, the second sensor fusion device, or a combination of the first sensor fusion device and the second sensor fusion device; and
transmitting, by the control device to the determination device, first data processed by the first sensor fusion device and second data processed by the second sensor fusion device.

16. The method of claim 13, wherein the performing, by the control device, of the first autonomous driving control comprises:
generating, by using the determination device, a plurality of determination results for avoiding the object;
selecting, by using the arbitration device, at least one determination result from among the plurality of determination results; and
performing, by the control device, the first autonomous driving control by performing, based on the selected at least one determination result, the first autonomous driving control.

17. The method of claim 16, wherein the selecting of the at least one determination result from among the plurality of determination results comprises:
selecting, by the control device, the at least one determination result, from among the plurality of determination results, based on at least one of:
a type of the object,
a determination whether the object is a moving object or a stationary object,
a size of the object, or
a movement speed of the object.

18. The method of claim 11, wherein the performing of the first autonomous driving control comprises:
based on the autonomous driving control level being higher than the specified level:
identifying, by the control device, the first autonomous driving control algorithm corresponding to the autonomous driving control level;
activating, by the control device, an obstacle avoidance control apparatus corresponding to the autonomous driving control level; and
performing, by the control device, the first autonomous driving control further based on the obstacle avoidance control apparatus.

19. The method of claim 18, wherein the first autonomous driving control algorithm comprises at least one of: an increase in driving speed limit, an expansion of sensing data overlap area, a change in user intent identification criterion, or an activation of determination of whether another vehicle cuts in.

20. The method of claim 18, wherein the obstacle avoidance control apparatus comprises a control apparatus for driving control for avoiding a stationary object, wherein the stationary object is an object present on the driving path of the vehicle.
